(19) United States
(12) Patent Application Publication
(10) Pub. No.: US 2026/0005360 A1
(43) Pub. Date: Jan. 1, 2026

(54) POWER STORAGE DEVICE

(71) Applicant: TOYOTA JIDOSHA KABUSHIKI KAISHA, Aichi-ken (JP)

(72) Inventors: Akio UOTANI, Nagoya-shi (JP); Dexu ZHANG, Mishima-shi (JP); Yoshinobu KUROYAMA, Aichi-gun (JP); Daisuke KAMESAKI, Okazaki-shi (JP); Seigo FUJISHIMA, Miyoshi-shi (JP); Yuki TAKAHASHI, Miyoshi-shi (JP)

(21) Appl. No.: 19/088,991

(22) Filed: Mar. 25, 2025

(30) Foreign Application Priority Data
Jun. 26, 2024 (JP) 2024-103115

(51) Int. Cl. H01M 50/24; B60K 1/04; B60L 50/60; B60L 50/64; H01M 50/30

(52) U.S. Cl. CPC H01M 50/24; B60K 1/04; B60L 50/64; B60L 50/66; H01M 50/30; B60K 2001/0438

(57) ABSTRACT

The power storage device includes a power storage module including a plurality of power storage stacks, and a housing case that houses the power storage module. The housing case includes a plurality of frame portions defining a region in which each of the plurality of power storage stacks is disposed. The plurality of frame portions includes a first frame portion in which an exhaust path through which gas is flowable is provided, and a second frame portion in which an exhaust path is not provided. The plurality of power storage stacks includes a first power storage stack and a second power storage stack disposed adjacent to each other. The first frame portion is disposed between the first power storage stack and the second power storage stack. The first frame portion has higher heat resistance than the second frame portion.

### CROSS-REFERENCE TO RELATED APPLICATION

This application claims priority to Japanese Patent Application No. 2024-103115 filed on Jun. 26, 2024, incorporated herein by reference in its entirety.

### BACKGROUND

### 1. Technical Field

The present disclosure relates to a power storage device, and more particularly, to a power storage device that is installed in a vehicle.

### 2. Description of Related Art

As a conventional power storage device, Japanese Unexamined Patent Application Publication (Translation of PCT Application) No. 2022-516519 (JP 2022-516519 A) discloses a structure in which part of a housing case that houses a plurality of power storage stacks is made up of a hollow member, and a hollow portion of the hollow member is used as an exhaust path. The hollow member is provided with a plurality of through holes through which gas that is discharged from the power storage device is introduced.

### SUMMARY

In JP 2022-516519 A, the hollow member (frame member) with the exhaust path provided therein is disposed between two power storage stacks that are adjacent to each other. When gas is discharged from one of the two power storage stacks that are adjacent to each other, high-temperature gas passes through the inside of the frame member that is disposed between the two power storage stacks. Accordingly, without any measures taken, there are cases in which the other one of the two power storage stacks that are adjacent to each other will be affected by heat, due to the frame portion melting, being damaged, or the like, by the heat.

The present disclosure has been made in view of the above-described problems, and an object of the present disclosure is to provide a power storage device that is capable of reducing effects of heat with respect to a power storage stack that is located adjacent to a frame portion that is provided with an exhaust path.

A power storage device according to the present disclosure includes a power storage module including a plurality of power storage stacks, and a housing case that houses the power storage module. The housing case includes a plurality of frame portions defining a region in which each of the power storage stacks is disposed. The frame portions include a first frame portion inside which an exhaust path is provided, through which gas that is discharged from the power storage module is flowable, and a second frame portion in which the exhaust path is not provided. The power storage stacks include a first power storage stack and a second power storage stack, that are disposed adjacent to each other. The first frame portion is disposed between the first power storage stack and the second power storage stack. Heat resistance of the first frame portion is higher than that of the second frame portion.

According to the above configuration, the heat resistance of the first frame portion is higher than that of the second frame portion. Accordingly, for example, when the high-temperature gas that is discharged from the first power storage stack flows through the exhaust path in the first frame portion, the first frame portion can be suppressed from melting, being damaged, or the like, by heat. Accordingly, heat can be suppressed from being transmitted from melted portions or damaged portions to the second power storage stack, and effects of the heat on the second power storage stack transmitted from the first frame portion can be reduced.

In the power storage device according to the present disclosure, the first frame portion and the second frame portion may extend in directions intersecting each other.

According to the above configuration, the second frame portion is not arrayed side by side with the first frame portion, and accordingly the effects of heat that is transmitted from the first frame portion, on the second frame portion, can be reduced.

In the power storage device according to the present disclosure, one end of the exhaust path may be located on a side toward the second frame portion, and also extend from the one end in a direction away from the second frame portion. In this case, the first frame portion may be provided with an opening that causes the one end of the exhaust path to communicate with a space in the housing case.

According to the above configuration, the gas flows in the direction away from the second frame, and accordingly the effects of heat on the second frame portion can be suppressed.

In the power storage device according to the present disclosure, the housing case may include a bottom wall portion to which the frame portions are fixed. Heat resistance of at least part of the first frame portion that is located in a periphery of the opening may be higher than that of the bottom wall portion.

According to the above configuration, the periphery of the opening for introducing the gas that is vented from the first power storage stack into the exhaust path has high heat resistance, and accordingly the periphery of the opening can be suppressed from being deformed or the like due to heat.

In the power storage device according to the present disclosure, the housing case may include a fixed portion that is fixed to a vehicle body. A corner portion may be fashioned in a region in which the first power storage stack is disposed by the first frame portion and the second frame portion abutting each other. The opening may be provided in a state facing the corner portion. Among the faces of each of the first frame portion and the second frame portion that face the power storage stacks, heat resistance of a portion facing the corner portion may be higher than that of the fixed portion.

According to the above configuration, the gas that is discharged from the first power storage stack readily accumulates in the corner portion, and the position of the corner portion readily tends to become hot. Among the faces of each of the first frame portion and the second frame portion that face the power storage stacks, the portions facing the corner portion have high heat resistance, and accordingly the first frame portion and the second frame portion can be suppressed from being damaged, deformed, or the like, by heat.

According to the present disclosure, a power storage device can be provided that is capable of reducing effects of heat on a power storage stack that is located adjacent to a frame portion provided with an exhaust path.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a vehicle according to an embodiment;

FIG. 2 is a schematic cross-sectional view showing a state in which the power storage device according to the embodiment is installed in a vehicle body; and

FIG. 3 is a schematic exploded perspective view of the power storage device according to the embodiment.

### DETAILED DESCRIPTION OF EMBODIMENTS

Hereinafter, embodiments of the present disclosure will be described in detail with reference to the drawings. In the following embodiments, the same or common parts are denoted by the same reference numerals in the drawings, and the description thereof will not be repeated.

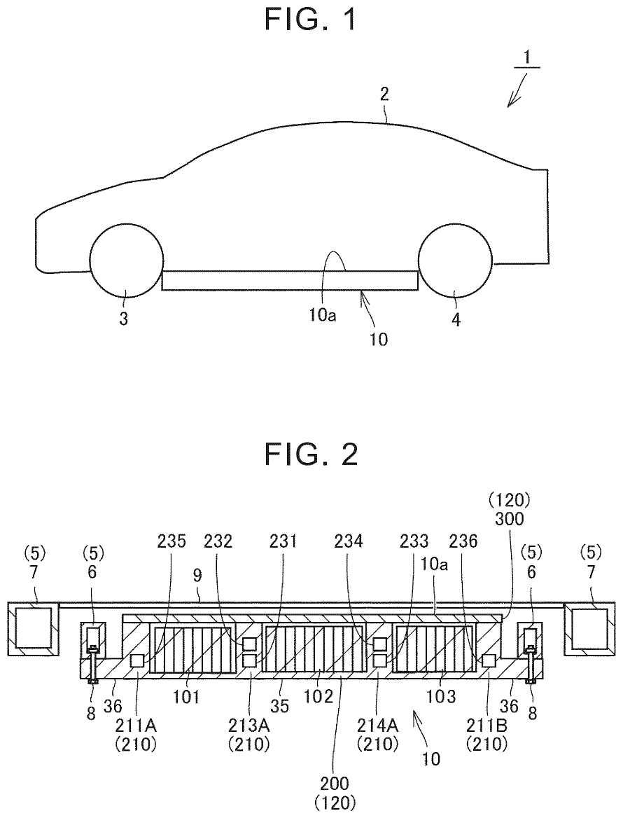

FIG. 1 is a schematic diagram illustrating a vehicle according to an embodiment. FIG. 2 is a schematic cross-sectional view illustrating a state in which the power storage device according to the embodiment is installed in a vehicle body. Referring to FIGS. 1 and 2, a vehicle 1 according to an embodiment will be described.

The vehicle 1 is a hybrid electric vehicle that can travel by using power of at least one of a motor and an engine, or an electrified vehicle that travels by a driving force obtained by electric energy.

As illustrated in FIG. 1, the vehicle 1 includes a vehicle body 2, a front wheel 3, a rear wheel 4, and a power storage device 10. The vehicle body 2 includes a frame member 5. The power storage device 10 is disposed on the lower side of the vehicle body 2. The power storage device 10 is disposed, for example, between the front wheel 3 and the rear wheel 4. Note that a part of the power storage device 10 may be disposed so as to overlap at least one of the front wheel 3 and the rear wheel 4 when viewed from the width direction of the vehicle 1. The power storage device 10 has an upper surface 10a. The upper surface 10a may function as a floor member defining the interior of the vehicle.

The frame member 5 includes a pair of side members 6 and a pair of side sills 7. The pair of side sills 7 are disposed on both end sides in the width direction of the vehicle 1. The pair of side members 6 are disposed inside the pair of side sills 7 at a distance. The pair of side members 6 and the pair of side sills 7 extend along the front-rear direction of the vehicle 1.

The pair of side members 6 are spaced apart in the width direction of the vehicle 1. A main body portion 35 of the power storage device 10 is disposed in a gap between the pair of side members 6. A gap is provided between the main body portion 35 and the pair of side members 6. Thus, even when the vehicle 1 collides laterally, it is possible to prevent an impact from being input to the power storage device 10.

The fixed portions 36 are provided on both side surfaces of the main body portion 35 in the width direction of the vehicle 1. The fixed portion 36 is fixed to the pair of side members 6 by the fastening member 8.

The frame member 5 also includes a cross frame member 9. The cross frame member 9 extends from one side sill 7 to the other side sill 7 above the power storage device 10. An upper surface 10a of the power storage device 10 is fixed to the cross frame member 9.

In the above description, a case in which the frame member 5 includes the pair of side members 6 and the pair of side sills 7 has been described as an example, but the present disclosure is not limited thereto. The pair of side sills 7 may also have the function of the pair of side members 6. In this case, the pair of side members 6 may be omitted, and the fixed portion 36 may be fixed to the pair of side sills 7.

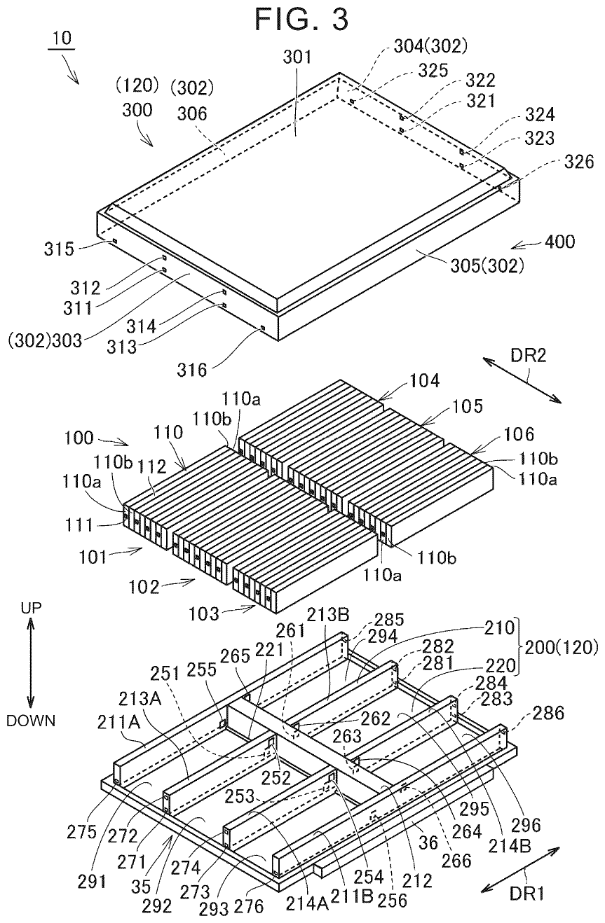

FIG. 3 is a schematic exploded perspective view of a power storage device according to Embodiment 1. A detailed structure of the power storage device 10 will be described with reference to FIGS. 2 and 3 described above.

The power storage module 100 includes a plurality of power storage stacks 101 to 106. The plurality of power storage stacks 101 to 106 are arranged in a matrix in the housing case 120. When the first direction (DR1 direction) is the column direction and the second direction (DR2 direction) is the row direction, the plurality of power storage stacks 101 to 106 are arranged in three rows and two columns. The first direction is, for example, parallel to the front-rear direction of the vehicle 1 in an installed state in which the power storage device 10 is installed in the vehicle body 2. The second direction is orthogonal to the first direction and is parallel to the left-right direction of the vehicle 1 in the installed state. The plurality of power storage stacks 101 to 106 are electrically connected in series.

Each of the plurality of power storage stacks 101 to 106 is configured in substantially the same manner. Here, the details of the power storage stack 101 will be described, and the descriptions of the other power storage stacks 102 to 105 will be omitted. In the present embodiment, the power storage stack 101 corresponds to the first power storage stack, and the power storage stack 102 corresponds to the second power storage stack.

The power storage stack 101 includes a plurality of unit cells 110. The plurality of unit cells 110 are arranged in the second direction, for example. The plurality of unit cells 110 are electrically connected in series.

The unit cell 110 has a longitudinal shape having a first direction as a longitudinal direction. The unit cell 110 has a flat rectangular parallelepiped shape having a thickness in the second direction.

The unit cell 110 includes a housing 112, and one or a plurality of electrode bodies are housed in the housing 112.

When a single electrode body is housed in the housing 112, the electrode body has a shape extending in the longitudinal direction. The electrode body may be a laminated electrode body in which a negative electrode sheet, a separator, and a positive electrode sheet are laminated, or may be a wound electrode body in which a negative electrode sheet, a separator, and a positive electrode sheet are wound.

When a plurality of electrode bodies are housed in the housing 112, the plurality of electrode bodies are arranged side by side in the longitudinal direction and are connected in series. Also in this case, the electrode body may be a laminated electrode body or a wound electrode body.

The unit cell 110 is a secondary battery such as a nickel metal hydride battery or a lithium-ion battery. The unit cell 110 may be a liquid electrolyte or a solid electrolyte. The unit cell 110 may be a chargeable/dischargeable capacitor.

The housing 112 is made of, for example, a metal material such as aluminum. The housing 112 includes a first end face 110a, a second end face 110b, and an exhaust valve 111 arranged in the first direction. The exhaust valve 111 is formed on the first end face 110a. The exhaust valve 111 opens when the internal pressure of the housing 112 exceeds a predetermined value, and discharges the gas in the housing 112 to the outside of the housing 112.

In each of the power storage stacks 101, the plurality of unit cells 110 are arranged in the second direction in a state in which the exhaust valves 111 are alternately positioned on one side in the first direction and the other side in the first direction. That is, the plurality of unit cells 110 are arranged such that the first end face 110a and the second end face 110b are alternately arranged in the second direction on one side and the other side in the first direction.

The housing case 120 includes an upper member 300 and a lower case 200. The upper member 300 has, for example, a substantially box-shaped shape that opens downward. The upper member 300 includes a top plate 301 and a peripheral wall 302. The peripheral wall 302 extends downward from an outer peripheral edge portion of the top plate 301. The peripheral wall 302 includes end walls 303 and 304 arranged in a first direction, and side walls 305 and 306 arranged in a second direction.

The end wall 303 is formed with external discharge ports 311 to 316. The end wall 304 is formed with external discharge ports 321 to 326. The external discharge ports 311 to 316 are through-holes penetrating the end wall 303, and the external discharge ports 321 to 326 are through-holes penetrating the end wall 304. The external discharge ports 311 to 316 communicate with the discharge ports 271 to 276 to be described later, and discharge the gas from the discharge ports 271 to 276 to the outside of the housing case 120. The external discharge ports 321 to 326 communicate with the discharge ports 281 to 286 to be described later, and discharge the gas from the discharge ports 281 to 286 to the outside of the housing case 120.

The lower case 200 includes a plurality of frame portions 210, a bottom wall portion 220, and a seal member 221. The plurality of frame portions 210 and the seal member 221 are provided on the upper surface of the bottom wall portion 220. The lower case 200 includes a main body portion 35 and a fixed portion 36. The main body portion 35 includes a plurality of frame portions 210 and a bottom wall portion 220. The fixed portions 36 are provided on both side surfaces of the main body portion 35 in the second direction. The fixed portion 36 is formed of a metallic member such as a SUS.

The plurality of frame portions 210 define a region in which the plurality of power storage stacks 101 to 106 are arranged. Each of the plurality of frame portions 210 is formed of a metal member. The plurality of frame portions 210 includes a pair of side frame portions 211A, 211B, a pair of first frame portions 213A, 214A, a second frame portion 212, and a pair of third frame portions 213B, 214B.

The pair of side frame portions 211A, 211B, the second frame portion 212, the pair of first frame portions 213A, 214A, and the pair of third frame portions 213B, 214B are fixed to the bottom wall portion.

The pair of first frame portions 213A, 214A and the second frame portion 212 extend across each other. Similarly, the pair of third frame portions 213B, 214B and the second frame portion 212 extend across each other. The pair of first frame portions 213A, 214A and the pair of third frame portions 213B, 214B extend in the first direction, and the second frame portion 212 extends in the second direction.

The pair of side frame portions 211A, 211B are spaced apart from each other in the second direction. The pair of side frame portions 211A, 211B are disposed on both sides of the bottom plate in the second direction. The pair of side frame portions 211A, 211B extend along the first direction.

The second frame portion 212 extends in the second direction on the upper surface of the bottom wall portion 220. The second frame portion 212 is disposed at a substantially central portion of the bottom wall portion 220 in the first directional DR1. The second frame portion 212 divides the space in the housing case 120 in the first direction.

The pair of first frame portions 213A, 214A is disposed in a space on one side in the first direction in the housing case 120 partitioned by the second frame portion 212. The pair of first frame portions 213A, 214A are disposed between the pair of side frame portions 211A, 211B on one side in the first direction. The pair of first frame portions 213A, 214A are spaced apart from the pair of side frame portions 211A, 211B and spaced apart from each other in the second direction.

The pair of first frame portions 213A, 214A divide the space in the housing case 120 located on one side in the first direction from the second frame portion 212 in the second direction. Specifically, the pair of first frame portions 213A, 214A divide the space on one side in the first direction in the housing case 120 into three spaces in the second direction.

In the space in the housing case located on one side in the first direction, the respective regions (the first region 291, the second region 292, and the third region 293) are partitioned by the pair of side frame portions 211A, 211B, the pair of first frame portions 213A, 214A, and the second frame portion 212. The power storage stacks 101 to 103 are arranged in the respective regions (the first region 291, the second region 292, and the third region 293).

The first frame portion 213A is disposed between the power storage stack 101 and the power storage stack 102, and the first frame portion 214A is disposed between the power storage stack 102 and the power storage stack 103.

The pair of third frame portions 213B, 214B is disposed in the space on the other side in the first direction in the housing case 120 partitioned by the second frame portion 212. The pair of third frame portions is disposed between the pair of side frame portions 211A, 211B on the other side in the first direction. The pair of third frame portions 213B, 214B are spaced apart from the pair of side frame portions 211A, 211B and spaced apart from each other in the second direction.

The pair of third frame portions 213B, 214B divide the space in the housing case 120 located on the other side in the first direction than the second frame portion 212 in the second direction. Specifically, the pair of third frame portions 213B, 214B divide the space in the housing case 120 on the other side in the first direction into three spaces in the second direction. In the space in the housing case located on the other side in the first direction, the respective regions (the fourth region 294, the fifth region 295, and the sixth region 296) are partitioned by the pair of side frame portions 211A, 211B, the pair of third frame portions 213B, 214B, and the second frame portion 212. In each region (the fourth region 294, the fifth region 295, and the sixth region 296), the power storage stacks 104 to 106 are respectively arranged.

The third frame portion 213B is disposed between the power storage stack 104 and the power storage stack 105, and the third frame portion 214B is disposed between the power storage stack 105 and the power storage stack 106.

Inside the pair of side frame portions 211A, 211B, the pair of first frame portions 213A, 214A, and the pair of third frame portions 213B, 214B, an exhaust path through which the gases discharged from the power storage stack are flowable is provided. Each exhaust path has one end on the second frame portion 212 side, and extends from the one end along a direction away from the second frame portion 212. Note that the second frame portion 212 is not provided with an exhaust path.

The pair of side frame portions 211A, 211B, the pair of first frame portions 213A, 214A, and the pair of third frame portions 213B, 214B have higher heat resistance than the second frame portion 212. The term “having high heat resistance” means, for example, that the pair of side frame portions 211A, 211B, the pair of first frame portions 213A, 214A, and the pair of third frame portions 213B, 214B are made of a material having a higher melting point than the second frame portion. The term “high heat resistance” means, for example, that a pair of side frame portions 211A, 211B, a pair of first frame portions 213A, 214A, and a heat resistance member such as mica are provided on the surfaces of the pair of third frame portions 213B, 214B.

The side frame portion 211A is provided with a discharge port 275, a discharge port 285, and an opening 255, 265. The discharge port 275 is provided on an end face of the side frame portion 211A located on one side in the first direction. The discharge port 285 is provided on an end face of the side frame portion 211A located on the other side in the first direction.

The opening 255 opens toward the first region 291. The opening 255 is opened on the second frame portion 212 side. Specifically, the opening 255 is provided such that one end of the second frame portion 212 located on one side in the second direction abuts against the side frame portion 211A and faces a corner portion formed in the first region 291. An exhaust path 235 (see FIG. 2) is provided inside the side frame portion 211A. The opening 255 allows the first region 291 to communicate with one end of the exhaust path 235 located on the second frame portion 212 side. The opening 255 communicates with the discharge port 275 via the exhaust path 235.

The opening 265 opens toward the fourth region 294. Specifically, the opening 265 is opened on the second frame portion 212 side. Specifically, the opening 265 is provided such that one end of the second frame portion 212 located on one side in the second direction abuts against the side frame portion 211A and faces a corner portion formed in the fourth region 294. An exhaust path (not shown) is provided inside the side frame portion 211A. The opening 265 communicates one end of the exhaust path located on the second frame portion 212 side with the fourth region 294. The opening 265 communicates with the discharge port 285 via the exhaust path.

An opening 251, 252 is provided in the first frame portion 213A. The opening 251 opens toward the first region 291. The opening 251 is provided on a main surface of the first frame portion 213A located on one side in the second direction. The opening 252 opens toward the second region 292. The opening 252 is provided on the main surface of the first frame portion 213A located on the other side in the second direction.

The opening 251, 252 is provided so as to face a corner portion formed in the first region 291 and the second region 292 when the first frame portion 213A abuts against the second frame portion 212. An exhaust path 231, 232 (see FIG. 2) is provided inside the first frame portion 213A. The opening 251 communicates one end of the exhaust path 231 with the first region 291, and the opening 252 communicates one end of the exhaust path 232 with the second region 292. The opening 251, 252 communicates with the discharge port 271, 272 via the exhaust path 231, 232. The discharge port 271, 272 is provided on an end face of the first frame portion 213A located on one side in the first direction.

An opening 253, 254 is provided in the first frame portion 214A. The opening 253 opens toward the second region 292. The opening 253 is provided on a main surface of the first frame portion 214A located on one side in the second direction. The opening 254 opens toward the third region 293. The opening 254 is provided on the main surface of the first frame portion 214A located on the other side in the second direction.

The opening 253, 254 is provided so as to face a corner portion formed in the second region 292 and the third region 293 when the first frame portion 214A abuts against the second frame portion 212. An exhaust path 233, 234 (see FIG. 2) is provided inside the first frame portion 214A. The opening 251 communicates one end of the exhaust path 233 with the second region 292, and the opening 254 communicates one end of the exhaust path 234 with the third region 293. The opening 253, 253 communicates with the discharge port 273, 274 via the exhaust path 233, 234. The discharge port 273, 274 is provided on an end face of the first frame portion 214A located on one side in the first direction.

An opening 261, 262 is provided in the third frame portion 213B. The opening 261 opens toward the fourth region 294. The opening 261 is provided on a main surface of the third frame portion 213B located on one side in the second direction. The opening 262 opens toward the fifth region 295. The opening 262 is provided on the main surface of the third frame portion 213B located on the other side in the second direction.

The opening 261, 262 is provided so as to face a corner portion formed in the fourth region 294 and the fifth region 295 when the third frame portion 213B abuts against the second frame portion 212. The opening 261, 262 communicates with the discharge port 281, 282 via an exhaust path (not shown) provided inside the third frame portion 213B. The discharge port 281, 282 is provided on an end face of the third frame portion 213B located on the other side in the first direction.

An opening 263, 264 is provided in the third frame portion 214B. The opening 263 opens toward the fifth region 295. The opening 263 is provided on a main surface of the third frame portion 214B located on one side in the second direction. The opening 264 opens toward the sixth region 296. The opening 264 is provided on the main surface of the third frame portion 214B located on the other side in the second direction.

The opening 263, 264 is provided so as to face a corner portion formed in the fifth region 295 and the sixth region 296 when the third frame portion 214B abuts against the second frame portion 212. The opening 263, 264 communicates with the discharge port 283, 284 via a flow path (not shown) provided inside the third frame portion 213B. The discharge port 283, 284 is provided on an end face of the third frame portion 214B located on the other side in the first direction.

The side frame portion 211B is provided with a discharge port 276, a discharge port 286, and an opening 256, 266. The discharge port 276 is provided on an end face of the side frame portion 211B located on one side in the first direction. The discharge port 286 is provided on an end face of the side frame portion 211B located on the other side in the first direction.

The opening 256 opens toward the third region 293. The opening 256 is opened on the second frame portion 212 side. Specifically, the opening 256 is provided in such a manner that the other end of the second frame portion 212 located on the other side in the second direction faces a corner portion formed in the third region 293 by abutting against the side frame portion 211B. An exhaust path 236 (see FIG. 2) is provided inside the side frame portion 211B. The opening 256 communicates one end of the exhaust path 236 located on the second frame portion 212 side with the third region 293. The opening 256 communicates with the discharge port 276 via the exhaust path 236.

The opening 266 opens toward the sixth region 296. Specifically, the opening 266 is opened on the second frame portion 212 side. Specifically, the opening 266 is provided in such a manner that the other end of the second frame portion 212 located on the other side in the second direction faces a corner portion formed in the sixth region 296 by abutting against the side frame portion 211B. An exhaust path (not shown) is provided inside the side frame portion 211B. The opening 266 communicates one end of the exhaust path located on the second frame portion 212 side with the sixth region 296. The opening 265 communicates with the discharge port 286 via the exhaust path.

Here, in the present embodiment, one of the unit cells 110 included in one of the power storage stack 101 and the power storage stack 102 may generate heat, and gas may be discharged from the unit cell 110. In this case, the gas is discharged to the outside of the housing case 120 through the exhaust path 231 or 232 provided in the first frame portion 213A disposed between the power storage stack 101 and the power storage stack 102.

At this time, since the first frame portion 213A has higher heat resistance than the second frame portion 212, even if the gases flow into the first frame portion 213A, the first frame portion 213 can be prevented from being melted or damaged by the heat. Accordingly, heat can be suppressed from being transmitted from melted portions or damaged portions to the second power storage stack, and effects of the heat on the second power storage stack transmitted from the first frame portion can be reduced. The first frame portion may have a lower heat dissipation property than the second frame portion.

A first frame portion 214A having higher heat resistance than that of the second frame portion 212 is disposed between the power storage stack 102 and the power storage stack 103. Therefore, the same effect as described above can be obtained even when any one of the unit cells 110 included in one of the power storage stacks 102 and 103 generates heat.

In addition, the third frame portion 213B, 214B has higher heat resistance than the second frame portion 212 on the other side in the first direction. Therefore, even when any one of the unit cells 110 included in any one of the power storage stacks 104 to 106 generates heat, it is possible to reduce the effects of heat on another power storage stack adjacent to any one of the power storage stacks while sandwiching the third frame portion through which the gas flows.

Further, the pair of side frame portions 211A, 211B, pair of first frame portions 213A, 214A, the pair of third frame portions 213B, 214B, and the second frame portion 212 extend in a direction intersecting each other. Accordingly, since the second frame portion 212 is not arranged side by side in the frame portion in which the exhaust path is provided, the effects of heat on the second frame portion transmitted from the frame portion can be reduced.

Further, since gas flows in the exhaust path provided in each frame portion in a direction away from the second frame portion 212, it is possible to suppress the effects of heat on the second frame portion.

In addition, in the pair of first frame portions 213A, 214A on the side frame portion 211A, 211B, and the frame portions on the pair of third frame portions 213B, the part located around the opening described above has higher heat resistance than the bottom wall portion 220. As a result, when the gas is introduced into the exhaust path from the opening, the periphery of the opening can be prevented from being deformed or the like due to heat.

In addition, when the gas is discharged as described above, the gas tends to accumulate in the respective corner portions formed by abutting the pair of side frame portions 211A, 211B, pair of first frame portions 213A, 214A, the pair of third frame portions 213B, 214B, and the second frame portion 212. Therefore, the position of the corner portion is likely to become hot. For this reason, a portion of the surface of each of the frame portions facing the power storage stack facing the corner portion has higher heat resistance than the fixed portion, so that it is possible to prevent the frame portions from being damaged or deformed. Specifically, for example, the first frame portion 213A, 214A and the portion facing the corner portion of the plane facing the power storage stack having each of the second frame portion 212 has a high heat resistance. Therefore, it is possible to prevent the first frame portion 213A, 214A and the second frame portion 212 from being thermally deformed.

In the above example, the first direction is parallel to the front-rear direction of the vehicle 1, and the second direction is parallel to the width direction of the vehicle 1, but the present disclosure is not limited thereto. The first direction may be parallel to the width direction of the vehicle 1, and the second direction may be parallel to the front-rear direction of the vehicle 1.

Further, in the above description, a case has been described in which each of the plurality of unit cells 110 has a longitudinal direction in the first direction and is arranged in the second direction in each of the power storage stacks, but the present disclosure is not limited thereto. In each of the power storage stacks, each of the plurality of unit cells 110 may have a longitudinal direction in the second direction and be arranged in the first direction. In this case, the exhaust valve 111 may be provided on the side surface of the housing 112 in the second direction.

Further, in the above description, the case where the upper member 300 has the top plate 301 and the peripheral wall 302 has been described as an example, but the present disclosure is not limited thereto, and the upper member 300 may be constituted only by the top plate 301. In this case, the lower case 200 may include a pair of side frame portions 211A, 211B and a first end wall portion connecting end faces located on one side of the pair of first frame portions 213A, 214A in the first direction. Further, the second end wall portion may include a pair of side frame portions 211A, 211B connecting end faces located on the other side in the first direction of each of the pair of third frame portions 213B, 214B. Further, in this case, the first end wall portion may be provided with an external discharge port communicating with the above-described discharge ports 271 to 276, and the second end wall portion may be provided with an external discharge port communicating with the above-described discharge ports 281 to 286.

The embodiments disclosed herein are illustrative and not restrictive in all respects. The scope of the present disclosure is defined by the claims, and includes all modifications within the meaning and range equivalent to the claims.

What is claimed is:

1. A power storage device, comprising:
a power storage module including a plurality of power storage stacks; and
a housing case that houses the power storage module, wherein
the housing case includes a plurality of frame portions defining a region in which each of the power storage stacks is disposed,
the frame portions include a first frame portion inside which an exhaust path is provided, through which gas that is discharged from the power storage module is flowable, and a second frame portion in which the exhaust path is not provided,
the power storage stacks include a first power storage stack and a second power storage stack, that are disposed adjacent to each other,
the first frame portion is disposed between the first power storage stack and the second power storage stack, and
heat resistance of the first frame portion is higher than that of the second frame portion.

2. The power storage device according to claim 1, wherein the first frame portion and the second frame portion extend in directions intersecting each other.

3. The power storage device according to claim 2, wherein:
one end of the exhaust path is located on a side toward the second frame portion, and also extends from the one end in a direction away from the second frame portion; and
the first frame portion is provided with an opening that causes the one end of the exhaust path to communicate with a space in the housing case.

4. The power storage device according to claim 3, wherein:
the housing case includes a bottom wall portion to which the frame portions are fixed; and
heat resistance of at least part of the first frame portion that is located in a periphery of the opening is higher than that of the bottom wall portion.

5. The power storage device according to claim 3, wherein:
the housing case includes a fixed portion that is fixed to a vehicle body;
a corner portion is fashioned in a region in which the first power storage stack is disposed by the first frame portion and the second frame portion abutting each other;
the opening is provided in a state facing the corner portion; and
among the faces of each of the first frame portion and the second frame portion that face the power storage stacks, heat resistance of a portion facing the corner portion is higher than that of the fixed portion.
